(19) United States
(12) Patent Application Publication
(10) Pub. No.: US 2012/0129680 A1
(43) Pub. Date: May 24, 2012

(54) HIGH-LEAD CONTENT GLASS

(76) Inventors: Jan Korensky, Jablonec nad Nisou (CZ); Kveta Sazavova, Jablonec nad Nisou (CZ); Jiri Vavrena, Semily (CZ)

(21) Appl. No.: 13/377,631

(22) PCT Filed: Jun. 9, 2010
(86) PCT No.: PCT/CZ10/00068

§ 371 Date: Feb. 9, 2012

(30) Foreign Application Priority Data
Jun. 10, 2009 (CZ) PV 2009-373

(51) Int. Cl. C03C 3/108

(52) U.S. Cl. 501/61

(57) ABSTRACT

High-lead content crystal glass shows with advantage the refraction index higher than 1.58, high light transmission, increased mechanical solidity and chemical resistance is suitable, especially, for the production and refinement of glass jewellery products, decorative and utility objects, including chandelier trimmings and semi-finished products. This glass contains, presented in % wt., 48 to 53% of silica SiO₂, 30 to 33% of lead monoxide PbO, 10 to 13% of the sum of potassium oxide and sodium oxide K₂O+Na₂O, 1 to 3% of calcium oxide CaO, 0.5 to 1% of zinc oxide ZnO, 0.5 to 1% of boron trioxide B₂O₃, less than 0.3 % of barium monoxide BaO, less than 0.3% of aluminium oxide AI₂O₃, 0.2 to 0.5% of antimony trioxide Sb₂O₃, 0.007 to 0.01% of oxides of iron.

### FIELD OF THE INVENTION

The invention relates to a crystal glass with a high content of lead. The crystal glass is advantageously used in a jewellery production.

### BACKGROUND OF THE INVENTION

The properties of crystal glass that is used in the field of utility and glass jewellery production respect the European directive on convergence of legal regulations of the member states relating to crystal glass No. 69/493 of Dec. 15, 1969. Directive No. 69/493/EEC provides for the requirements for the properties of crystal glass depending on composition, density, refraction index and surface hardness.

Used for the products requiring marked optic-aesthetic properties, as a rule, are compositions containing lead monoxide >30% wt. (category 1, Directive No. 69/493).

At present, used most frequently is high-lead content glass the typical composition of which is 48 to 55% of SiO₂, 30 to 33% PbO, 10 to 15% K₂O+Na₂O, completed with stabilizing oxides AI₂O₃, ZnO, BaO, B₂O₃, and that show the following properties:

| | | Determination- |
|---|---|---|
| Name of property | Value | regulation |
| Density | ≧3000 kg/m³ | \check{C}SN 70 0513 |
| Refraction index-n_{D} | ≧1.545 | \check{C}SN 70 0545 |
| Mean dispersion | ≧0.013 | \check{C}SN 70 0545 |
| Light transmission | ≧93% | \check{C}SN 01 1718 |
| Linear thermal expansion | ≧9.0 × 10⁻⁶ | \check{C}SN ISO 7991 |
| mean coefficient α (20-300)° C. | K⁻¹ | |
| Softening point-Littleton | ≧600° C. | \check{C}SN ISO 7884-6 |
| Water resistance | HGB 3 | \check{C}SN ISO 719 |
| Young's modulus E | ≧60 000 MPa | Measurement of speed |
| | | of UZ waves |
| Poison's ratio μ | ≧0.2 | Measurement of speed |
| | | of UZ waves |

Used in the manufacture of utility and glass jewellery objects and in their use the refined crystal products are subject to mechanical and chemical strain (Gotz). By the influence of mechanical forces the edges and surface of the products might be damaged (scratched). Acting in parallel with this factor are physical—chemical influences of the environment in which the products appear (Rana).

At room temperature glass may be considered a solid substance and the ratio between the acting force and deformation on tension or pressure strain is given by the Hook law.

Young's moduluses are influenced by the chemical composition, temperature, crystallization, cooling of the semi-finished product, etc. (Fanderlik). Young's moduluses are connected with the solidity of bonds and closeness of arrangement of particles in the glass network.

The solidity of glass is increased by oxides that increase chemical resistance (Volf). Higher E values mean that glass is less deformed by the effect of external forces.

### SUMMARY OF THE INVENTION

The invention relates to high-lead content crystal glass that shows with advantage refraction index ≧1.58 at 589.3 nm and high light transmission, further, increased mechanical solidity and chemical resistance.

According to this invention the improvement of high-lead content crystal optic aesthetic and utility properties is achieved by glass composition containing oxides in % wt.:
50 to 53% of silica SiO₂
30 to 33% of lead monoxide PbO
10 to 13% sum of potassium oxide and sodium oxide K₂O+Na₂O
1 to 3% of calcium oxide Ca0
0.5 to 1% of zinc oxide ZnO
0.5 to 1% of boron trioxide B₂O₃
less than 0.3% of barium monoxide BaO
less than 0.3% of aluminium oxide Al₂O₃
0.2 to 0.5% of antimony trioxide Sb₂O₃
0.006 to 0.01% of oxides of iron.

In the proposed high-lead content glass the depressive influence of barium monoxide is suppressed and, on the contrary, the positive influence of calcium oxide on Young's modulus E is strengthened.

Mechanical properties of the glass depend on the solidity of bond cation—oxygen and on the deformability of ions. With divalent elements the ion potential decreases in the line Ca—Sr—Pb—Ba. Deformability of lead ions changes the order of elements into the new line Ca—Sr—Ba—Pb.

Deformability of lead ions causes that lead containing glass is softer by 20% than barium glass. With increasing content of PbO the E values decrease.

For glass containing around 30% of PbO of common composition the Young's modulus E ≦60 000 MPa. By using the proposed composition according to this invention E value will increase minimum to 70 000 MPa. The advantage of the presence of calcium oxide in lead containing glass according to the invention is that in parallel chemical resistance increases both to water and to acids and alkalis.

According to this invention boron tribxide influences the Young's modulus E within a very wide extent. If alkalis prevail over boron trioxide and the ratio of ion radiuses is larger than 2, the influence (factor) of B₂O₃ achieves also in minority quantity the maximum increase of the Young's modulus E. Boron oxide as the minority component does not influence chemical resistance, but increases the lustre of the products. It is caused by the orientation of the bonds cation—oxygen (coordination number 3) for boron atoms.

Zinc oxide then improves the hardness of glass in comparison with the elements of triad Ca—Sr—Ba. In comparison with those elements it is characterized also by larger solidity of bond to oxygen. Zinc oxide improves glass chemical resistance to the effects of water. However, with acid and alkali leaches calcium oxide is more efficient.

### DETAIL DESCRIPTION OF THE EMBODIMENTS

The examples of types of the invention and properties of glass are presented in the following tables.

| | Example No. | |
|---|---|---|
| | 1 | 2 |
| Glass components | content of oxides in % wt. | |
| Silica SiO₂ | 51.36 | 51.22 |
| Lead monoxide PbO | 32.00 | 31.90 |
| Zinc oxide ZnO | 0.71 | 0.71 |
| Calcium oxide CaO | 1.96 | 1.96 |
| Potassium oxide K₂O | 6.58 | 6.56 |
| Sodium oxide Na₂O | 6.31 | 6.18 |
| Boron trioxide B₂O₃ | 0.77 | 1.16 |
| Aluminium oxide Al₂O₃ | 0.1 | 0.1 |
| Antimony trioxide Sb₂O₃ | 0.21 | 0.21 |
| Neodymium oxide Nd₂O₃ | 0.002 | 0.002 |
| Erbium oxide Er₂O₃ | 0.02 | 0.02 |

Properties of glass according to example types:

| | | |
|---|---|---|
| T_{L} (° C.) | 632.8 | 627.5 |
| T_{G} (° C.) | 465.35 | 464.25 |
| Tₘ (° C.) | 532.25 | 523.50 |
| T ₜₐᵥ (° C.) | 1232 | 1237 |
| α 10⁻⁶ (K⁻¹) | 10.4109 | 9.4568 |
| Refraction index at 589.3 nm | 1.5804* | 1.5803* |
| Nominal luminosity | ≧93 | ≧93 |
| (dimensionless) | | |
| Abbe's number | 60.21* | 60.34* |
| Class of water resistance | 3. | 3. |
| Density (g/cm³) | 3.202 | (3.176*) |
| | (3.180*) | |
| Grinding hardness (mm³/s) | 2.648 | 2.504 |
| Polishability (mm³/s) | 0.0558 | 0.0518 |

*-calculated values

Example number 1 represents electrically molten glass with the share of 50% wt. of cullets themselves. The glass according to example 1 is usable for the production of utility objects, including chandelier trimmings and semi-finished products or for the production of minor glass jewellery moulded pieces by one-stage technology.

Example number 2 represents molten glass molten at gas glass-making unit with the share of 40% wt. of cullets themselves. The glass according to this example is intended for the production of rods or glass jewellery semi-finished products by one-and two-stage technologies.

### INDUSTRIAL APPLICABILITY

The invention is especially suitable for the production of glass for making decorative and glass jewellery objects. Of course, it is also possible to use it anywhere else where it will be suitable thanks to its properties.

1/ High-lead content glass characterized in that it contains % wt:
50 to 53% of SiO₂
30 to 33% of PbO
10 to 13% of sum of K₂O+Na₂O
1 to 3% of CaO
0.5 to 1% of ZnO
0.5 to 1% of B₂O₃
less than 0.3% of BaO
less than 0.3% of Al₂O₃
0.2 to 0.5% of Sb₂O₃
0.07 to 0.01% of oxides of iron

2/ High-lead content glass according to claim 1 characterized in that the weight ratio of oxide BaO and oxide CaO is 1:3 to 1:10.

3/ High-lead content glass according to claim 1 characterized in that the sum of % wt. of oxides B₂O₃ and ZnO is ≦2%.

4/ High-lead content glass according to claim 1 characterized in that the Young's modulus E achieves minimum 70.000 Mpa.

5/ High-lead content glass according to claim 1 characterized in that the content of potassium oxide is higher than the content of sodium oxide.
